(19) United States
(12) Patent Application Publication
(10) Pub. No.: US 2017/0209738 A1
(43) Pub. Date: Jul. 27, 2017

(54) GARMENT AND SYSTEM FOR BASEBALL SWING ANALYSIS

(71) Applicant: VF Imagewear, Inc., Nashville, TN (US)

(72) Inventor: Christopher Brennan, Lehighton, PA (US)

(21) Appl. No.: 15/408,044

(22) Filed: Jan. 17, 2017

Related U.S. Application Data
(60) Provisional application No. 62/281,450, filed on Jan. 21, 2016.

(51) Int. Cl. A63B 24/00; A41D 1/00; A63B 69/00; A63B 71/06; G09B 19/00; A41B 1/08; A41D 1/04

(52) U.S. Cl. CPC A63B 24/0006; A41B 1/08; A41D 1/005; A41D 1/04; A63B 71/0622; G09B 19/0038; A63B 69/0002; A41D 2600/10; A63B 2225/50; A63B 2220/836; A63B 2220/30; A63B 2220/40; A63B 2220/803; A63B 2220/62; A63B 2069/0008

(57) ABSTRACT

Embodiments of the present disclosure relate to a garment, such as a shirt, that is configured for analyzing a wearer's baseball swing. The garment contains a plurality of sensors including (1) a wrist sensor that is configured to detect the motion of a wearer's wrist or hand during the swinging motion, (2) a shoulder sensor that is configured to detect the motion of a wearer's shoulder during the swinging motion, and (3) a hip sensor that is configured to detect the motion of a wearer's hip during the swinging motion. In some embodiments, these are the only three sensors present in the garment. In other embodiments, the garment may also include additional sensors. The garment also includes a wireless transmitter that is configured to transmit the data from the plurality of sensors to an external processing and/or display unit.

This application claims priority to U.S. Provisional Application No. 62/281,450, filed on Jan. 21, 2016, the entirety of which is hereby incorporated by reference.

### BACKGROUND OF THE INVENTION

The science behind a successful baseball swing is complex, taking into account many factors. Often bat speed or a combination of bat speed and swing plane are used to analyze a player's swing. Information regarding the kinetics of the player's body during the swing is generally only available by repeated and careful video analysis. Even then, the results are imprecise and depend on the skill of the player or hitting coach to spot and properly analyze problem areas. The system of the present disclosure allows one to obtain precisely measured data that demonstrates the kinetics of a player's body during a swing. This data may be used in a variety of ways in order to help a player recognize one or more problem areas and thereby develop a more successful swing. This data may also be used in scouting baseball players, such as by providing data concerning the kinetics of a player's body during a swing and/or the consistency of a player's body movement throughout multiple swings.

### SUMMARY OF THE INVENTION

Embodiments of the present disclosure relate to a garment, such as a shirt, that is configured for analyzing a wearer's baseball swing. The garment contains a plurality of sensors including (1) a wrist sensor that is configured to detect the motion of a wearer's wrist or hand during the swinging motion, (2) a shoulder sensor that is configured to detect the motion of a wearer's shoulder during the swinging motion, and (3) a hip sensor that is configured to detect the motion of a wearer's hip during the swinging motion. In some embodiments, these are the only three sensors present in the garment. In other embodiments, the garment may also include additional sensors. The garment also includes a wireless transmitter that is configured to transmit the data from the plurality of sensors to an external processing and/or display unit.

In some embodiments of the garment, the plurality of sensors may be connected to one another and to the wireless transmitter through a flexible ribbon. The data from the plurality of sensors may be conveyed to the wireless transmitter through the flexible ribbon. The flexible ribbon is desirably incorporated into the garment so as not to interfere with the wearer's motion. For example, in some embodiments the flexible ribbon may extend through a tunnel that is formed into the fabric of the garment. The sensors are desirably of a sufficiently small size so as not to interfere with the wearer's motion. Indeed, in some embodiments the sensors may be of a sufficiently small size that a wearer would not notice their presence during the swinging motion. For example, each sensor may desirably be less than one inch by one inch and have a thickness that is less than one-quarter of an inch. The sensors are also desirably not visible on the exterior of the garment. For example, in some embodiments the garment may have the outward appearance of being a standard or high-performance shirt. For example, the garment may be a high-performance training shirt, a compression undergarment that is designed to be worn under a baseball jersey, a baseball jersey, or the like.

In some embodiments, one or more of the sensors are irremovably incorporated into the garment. For example, each of the plurality of sensors may be irremovably incorporated into the garment. Alternatively, each of the wrist sensor and shoulder sensor may be irremovably incorporated in the garment and the hip sensor may be removable (such as by being incorporated into a removable control module). The irremovably incorporated sensors are desirably incorporated in a manner that allows the garment to be machine-washable without damaging the sensors.

In some embodiments, the garment includes a control module. The control module may include, for example, the wireless transmitter, a power source, a charging port, an on-off switch, and the like. Desirably, the control module may easily be attached to the garment and connected with the plurality of sensors. For example, in some embodiments the garment may comprise a pocket, such as an internal pocket, that is configured to hold the control module. The pocket may be located at a position by which it may easily be linked with the plurality of sensors, such as by plugging one end of a flexible ribbon that connects the sensors into the control unit. For example, the pocket may be located at a wearer's hip or lower back.

Embodiments of the present disclosure also relate to a system for analyzing a user's baseball swing. The system includes a garment such as any of those described herein, a processor configured to convert the raw data from the plurality of sensors into user swing information, and a display configured for displaying the user swing information. In some embodiments, the processor and display may be components of a personal computer, such as a desktop or laptop computer, or of a mobile device, such as a smartphone or tablet.

In some embodiments, the user swing information may comprise any of a number of different swing metrics. For example, the user swing information may include a user's swing plane; hand speed; swing acceleration; maximum acceleration; hit angle; bat speed; time in the strike zone; hit point; information regarding the relative timing of hip, shoulder, and/or wrist movements; or combinations thereof. The user swing information may be displayed in any number of ways, including for example graphically, with animations, by comparison to a control or target swing, and the like. In some embodiments, the system may be configured to store and compare user swing information from multiple swings, such as swings from one or more training sessions. The system may also be configured to share user swing information, such as over the Internet.

In some embodiments, the system may be configured to have multiple modes, with the user swing information that is displayed in each mode being different. For example, the system may include a first mode and a second mode, with the user swing information that is selectable in the first mode being different from the user swing information that is selectable in the second mode. The first mode may be streamlined to provide basic, easy to use swing metrics, such as the type that may be immediately incorporated into a user's training session. The second mode may provide more advanced swing metrics and analytics that may be used to analyze a user's swing over time.

Embodiments of the present disclosure also relate to a method for analyzing a user's baseball swing. The method involves providing a garment such as any of those disclosed herein; causing a user to wear the garment while performing a baseball swing; and transmitting the data from the plurality of sensors to an external unit, where the raw data is processed into user swing information and the user swing information is displayed. In some embodiments, the user swing information may comprise any of a number of different swing metrics. For example, the user swing information may include a user's swing plane; hand speed; swing acceleration; maximum acceleration; hit angle; bat speed; time in the strike zone; hit point; information regarding the relative timing of hip, shoulder, and/or wrist movements; or combinations thereof. The user swing information may be displayed in any number of ways, including for example graphically, with animations, by comparison to a control swing, and the like. In some embodiments the external unit may be positioned so that it can be viewed by a user without requiring the user to step out of a batter's box.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is an illustration of a garment according to an embodiment of the present disclosure.

FIG. 2 is an illustration of a system configured to display streamlined swing data according to an embodiment of the present disclosure.

FIG. 3 is an illustration of a system configured to display advanced swing data according to an embodiment of the present disclosure.

FIG. 4 is an illustration of an electronic system of the sort that may be incorporated into a garment according to an embodiment of the present disclosure.

FIG. 5 is an illustration of a garment according to an embodiment of the present disclosure.

FIG. 6 is an illustration of a garment according to an embodiment of the present disclosure.

### DETAILED DESCRIPTION OF THE INVENTION

Reference will now be made in detail to certain embodiment(s), examples of which are illustrated in the accompanying drawings. Whenever possible, the same reference numerals will be used throughout the drawings to refer to the same or like parts.

### The Garment

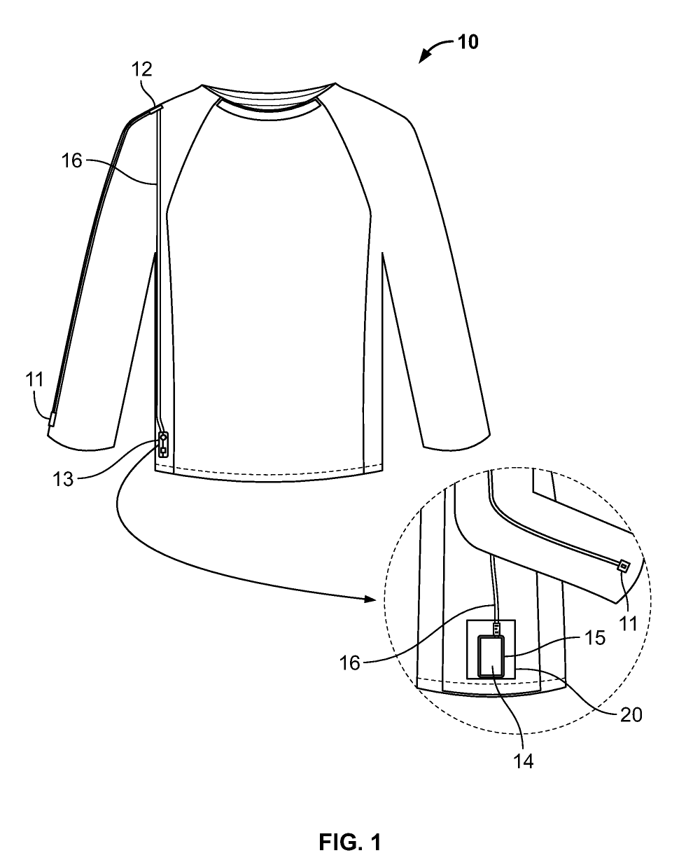

An embodiment of the garment 10 is shown in FIG. 1. The garment 10 comprises a plurality of sensors, with each sensor being located at a position on the garment so as to provide data that is relevant to the analysis of a wearer's baseball swing. In the embodiment shown in FIG. 1, for example, the garment 10 comprises a wrist sensor 11, a shoulder sensor 12, and a hip sensor 13. Each sensor may be configured to detect the movement of the user's body at the corresponding location during a baseball swinging motion. For example, the wrist sensor 11 is configured to detect the motion of a wearer's hand or wrist when the user performs a baseball swing, the shoulder sensor 12 is configured to detect the motion of a wearer's shoulder during a baseball swing, and the hip sensor 13 is configured to detect the motion of a wearer's hip during a baseball swing.

In other, non-illustrated embodiments, the garment 10 may comprise one or more additional sensors. For example, in some embodiments, the garment may comprise an additional wrist sensor 11, providing a garment that includes a sensor at each of a wearer's wrists. In some embodiments, the garment 10 may comprise an additional shoulder sensor 12 so that the garment includes a sensor at each of a wearer's shoulder. And in some embodiments, the garment 10 may comprise an additional hip sensor 13 so that the garment includes a sensor at each of a wearer's hips. Any of these additional sensors may be provided in order to increase the amount of raw data that may be used in calculating user swing information. Alternatively, one or more of these additional sensors may be provided in order to provide a garment 10 that is configured for use by a switch-hitter or by multiple users, such as a user that batted from the right side and a user that batted from the left side.

Additional sensors located elsewhere on the garment are also contemplated for use with the presently disclosed garment. However, the inventors have found that the combination of wrist sensor 11, shoulder sensor 12, and hip sensor 13 provides all of the necessary information from which an array of useful swing information may be calculated. Accordingly, by placing sensors only at these three locations, embodiments of the garments 10 of the present disclosure may be cost-effectively produced and provide a level of wearer comfort that may be unattainable with larger numbers of sensors.

Although the embodiment illustrated in FIG. 1 is configured for use by a right-handed batter, the garment 10 may also be configured for use by a left-handed batter, such as for example by moving each of the sensors 11, 12, 13 to the opposite wrist, shoulder, and hip. Embodiments of the garment 10 that may be used by a right-handed batter or a left-handed batter are also contemplated. For example, the garment 10 may comprise sensors on both sides (e.g. both shoulders, both hips, one or both wrists) or the garment may be configured so that it can be reversibly worn so that the sensors may be positioned at either side of the garment depending on how the garment is donned.

Each sensor may be configured to detect, and in some embodiments measure, a variety of motions across numerous planes. For example, each sensor may comprise one or more accelerometers and/or one or more gyroscopes. Each sensor may also comprise one or more magnetometers. For instance, each sensor may include an inertial measurement unit (IMU). In some embodiments, the IMU may be a three-axis IMU, which comprises three accelerometers, three gyroscopes, and optionally three magnetometers. Each component on the sensor may be mounted to a printed circuit board (PCB).

Each sensor may either be incorporated into the garment in a manner that allows one to detach the sensor from the garment, i.e. removably incorporated into the garment, or in such a way that the sensor is not intended to be detached from the garment, i.e. irremovably incorporated into the garment. For example, one or more of the plurality of sensors may be irremovably incorporated into the garment by being sewn into the garment. In some embodiments, each of the plurality of sensors may be irremovably incorporated into the garment. In some embodiments, such as the embodiment illustrated in FIG. 1, at least the wrist sensor 11 and shoulder sensor 12 are each irremovably incorporated into the garment, such as by being sewn into the garment. This ensures that the sensors 11, 12 are maintained in the proper location throughout repeated swinging motions and that a user need do nothing more than don the garment 10 in order to properly position the sensors. The hip sensor 13 may also be irremovably incorporated into the garment 10, or it may be removably incorporated into the garment such as by being integrated with a control module 15 as in the embodiment shown in FIG. 1.

Where the garment 10 contains one or more irremovably incorporated sensors, it is also desirable that the garment 10 be configured so as to be washable without damaging the sensors. For example, in some embodiments the garment 10 is configured so as to be machine-washable without causing damage to the one or more irremovably incorporated sensors. For example, the sensor, including any connection points, may be coated with a waterproof material, such as a waterproof epoxy. In some embodiments where one or more of the sensors are electrically connected to a flexible ribbon, as will be subsequently described in greater detail, the sensor and its point or points of connection with the flexible ribbon are coated with a waterproof epoxy. Optionally, the coated sensor and its connection point(s) may also be provided with a reinforcing layer, such as a vulcanized silicone. The inclusion of a reinforcement layer may provide an added layer of stress protection to the connections point(s) and the wire exits.

In some embodiments, each of the sensors is desirably configured so as to be substantially unnoticeable to a wearer, especially during a swinging motion. For example, each of the plurality of sensors may have a thickness that is less than one-half of an inch, alternatively less than one-quarter of an inch. Each sensor may also desirably be sized at one inch by one inch or less. Through careful selection and placement of the sensors, embodiments of the garment 10 serve to integrate technology into a garment in a way that is substantially unnoticeable to the wearer.

The garment 10 also desirably comprises a wireless transmitter 14 that is configured to transmit the data collected by the plurality of sensors to an external unit. The wireless transmitter 14 may be positioned anywhere on the garment. The wireless transmitter 14 is desirably positioned at a location where it will not interfere with the wearer's swinging motion. In some embodiments, such as that illustrated in FIG. 1, the wireless transmitter 14 is incorporated into a control module 15. The type of wireless communication technology that is employed by the wireless transmitter 14 is not limited and may be selected from those generally known in the art, such as Wi-Fi, Bluetooth or other radio wave-based wireless, induction wireless, infrared wireless, ultra wideband (UWB), or the like. In alternative embodiments, the garment 10 may be plugged into an external display unit.

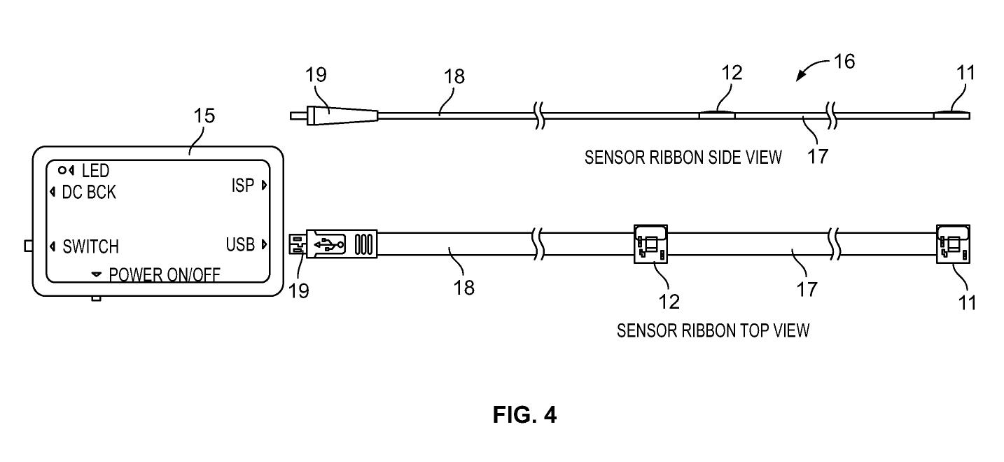

In some embodiments, the sensors are connected to the wireless transmitter 14 or the control module 15, and optionally to one another, through a flexible ribbon 16. An embodiment of the flexible ribbon 16 is shown in FIG. 4. The flexible ribbon 16 is configured so as to not restrict movement of the garment or otherwise limit a wearer's swinging motion. The flexible ribbon 16 comprises one or more flexible wires, cables, or the like through which the sensor data may be conveyed to the wireless transmitter 14 or the control module 15. The flexible ribbon 16 may also comprise a protective covering. The protective covering may be made of a number of materials. In some embodiments, for example, the flexible ribbon 16 may comprise a polyester coating of each copper strand, which ensures that the flexible ribbon is waterproof.

The flexible ribbon 16 is desirably of sufficient thinness so that it will not be felt by a wearer of the garment 10. For example, the flexible ribbon 16 may be less than one-quarter of an inch thick, alternatively less than one-eighth of an inch thick, alternatively less than one-twelfth of an inch thick, alternatively less than one-sixteenth of an inch thick. The width of the flexible ribbon 16 may vary. In some embodiments, the flexible ribbon may have a width that is less than one-third of an inch, alternatively less than one-quarter of an inch. The length and positioning of the flexible ribbon 16 is determined by the arrangement of the plurality of sensors and the size of the garment 10 into which the sensors and ribbon are incorporated.

For example, in the embodiment that is illustrated in FIG. 4, which is designed for use with the embodiment of the garment 10 illustrated in FIG. 1, the flexible ribbon comprises a first portion 17 that is configured to connect the wrist sensor 11 with the shoulder sensor 12 and a second portion 18 that is configured to connect the shoulder sensor with the control module 15 (in which the hip sensor 13 is integrated). In this embodiment, for example, the length of the first portion 17 may be between about 550 mm and about 750 mm, alternatively between about 570 mm and about 710 mm, depending on the size of the garment 10. And, for example, the length of the second portion 18 may be between about 550 mm and about 750 mm, alternatively between about 600 mm and about 750 mm, depending on the size of the garment 10.

In an alternative embodiment, the hip sensor 13 may also be irremovably incorporated into the garment 10. Accordingly, the flexible ribbon 16 may also comprise a third portion that is configured to connect the hip sensor 13 with the control module 15, which may be located elsewhere on the garment, such as at a position that corresponds with the lower back of a wearer. In this embodiment, the second portion 18 may be configured to connect the shoulder sensor 12 with either of the hip sensor 13 or the control module 15. In other embodiments, such as where one or more additional sensors may be included in the garment 10, the flexible ribbon 16 may take on any number of different configurations and include any number of portions.

In some embodiments, the flexible ribbon 16 may be configured to removably connect with a control module 15. For example, the flexible ribbon 16 may comprise a connector 19 that is configured to link to a control module 15. The connector 19 may take on any number of formats, so long as it is capable of securely connecting with the control module 15. In the embodiment shown in FIG. 4, for example, the connector 19 is illustrated as having a micro USB format, although any number of alternative formats are also contemplated. In some embodiments, the connector 19 may be configured to provide a connection by which the control module 15 may be securely affixed to the garment 10.

The flexible ribbon 16 may be incorporated into the garment 10 in any number of ways. In some embodiments, for example, the garment may comprise a tunnel through which the flexible ribbon extends. The tunnel may be sewn into the garment in a manner so as to be flush with the rest of the interior of the garment, rendering the flexible ribbon 16 substantially unnoticeable to a wearer. In some embodiments, the flexible ribbon 16 may be sewn into the garment.

Embodiments of the garment 10 also comprise a control module 15. As previously described, in some embodiments the control module 15 may comprise the wireless transmitter 14, the hip sensor 13, or both. The control module 15 may also comprise a power source for the sensors, such as a rechargeable battery. The control module 15 may also comprise a port by which the power source may be charged, such as through connection of a charging cable. The control module may also comprise a power switch, by which the control module may be switched between “on” and “off” settings. The control module 15 may also comprise an indicator, such as a light, that indicates whether the control module is “on” or “off”. In some embodiments, the control module 15 may include one or more processors, which may be configured to process the data from the plurality of sensors prior to wireless transmission.

The control module 15 may be removably or irremovably incorporated into the garment 10. In some embodiments, the control module 15 is desirably removably incorporated into the garment 10. For example, in some embodiments, the garment 10 may comprise a pocket 20 into which the control module may be placed. The pocket 20 may be located on the interior of the garment 10 at a variety of positions. For example, in the embodiment shown in FIG. 1, the garment 10 comprises a pocket 20 located at an interior position that corresponds with the hip of the wearer. In alternate embodiments, the pocket 20 may be located at a position that corresponds with the lower back of the wearer. Where the plurality of sensors are connected with the control module 15 by a flexible ribbon 16 which is incorporated into a tunnel formed in the garment, as described above, the tunnel may comprise an opening that is adjacent to and communicates with the pocket 20. In this way, the flexible ribbon 16 may be connected to the control module 15, such as by inserting the connector 19 into a port in the control module. Together, the tunnel and the pocket 20 desirably form a layer of fabric that prevents contact of either the flexible ribbon 16 or the control module 15 with the wearer, while still allowing for a user to remove the control module 15, such as for laundering of the garment, charging of the power source, and the like. Alternatively, the control module 15 may simply be clipped or otherwise affixed to the garment by the user in any of a variety of locations.

In some embodiments, for example where it may be desirable to showcase the technology, the control module 15 may be located at an exterior position on the garment 10. Accordingly, embodiments of the garment 10 may comprise a connector 19 on the exterior of the garment. For instance, the garment 10 may comprise a snap-secure connector 19 at a desired location on the exterior of the garment, to which the control module 15 may be affixed. In this way, one may securely affix the control module 15 to the garment 10 simply by attaching it to the exterior connector 19. The location of the exterior connector 19 on the garment 10 may vary. For example, the exterior connector 19 may be located at a location on the garment 10 that corresponds with the hip of the wearer, alternatively a location that corresponds with the lower back of the wearer, etc.

In some embodiments, the garment 10 of the present disclosure is designed to fit tightly against the skin of the wearer so as to ensure accurate and precise readings from the plurality of sensors. For example, the garment 10 may be made of a stretchable, optionally high-performance fabric. A high-performance shirt is configured to provide moisture wicking, stretch, and breathability properties that are of particular benefit during athletic training. High performance shirts may be made from a blend of polyester and spandex, such as a blend of about 92% Polyester and about 8% Spandex. In some embodiments, the garment 10 is configured so that the plurality of sensors, as well as other elements that may be present (such as a control module 15 and/or flexible ribbon 16), are not visible on the exterior of the garment. This desirably provides the garment 10 with the outward appearance of being, for example, a conventional high-performance garment, such as that illustrated in FIG. 1. It is contemplated that a wearer could wear the garment 10 of the present disclosure either on its own or as a base layer underneath another shirt, such as a baseball jersey or uniform shirt.

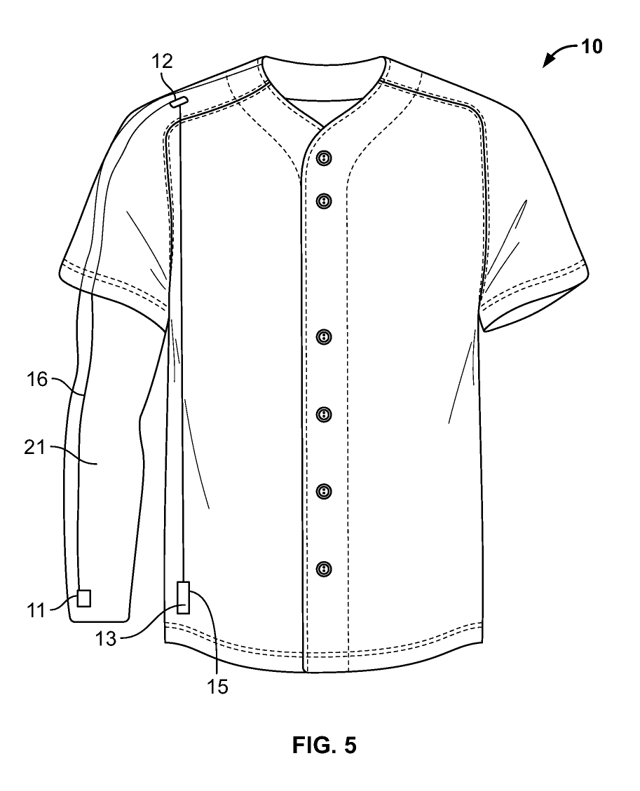

In some embodiments, the garment 10 of the present disclosure may comprise a baseball jersey. Baseball jerseys, however, are conventionally short-sleeved and thus lack a location for the wrist sensor 11. Accordingly, in some embodiments, such as that illustrated in FIG. 5, the garment may comprise a (short-sleeved) baseball jersey having one or more long sleeves 21 attached. The one or more long sleeves 21 may be attached to the short-sleeved baseball jersey by any conventional manner. For example, the one or more long sleeves 21 may be sewn into the interior of the short-sleeved baseball jersey. The one or more long sleeves 21 may be made of a stretchable, optionally high-performance fabric. For example, in some embodiments, at least one of the one or more long sleeves 21 may comprise a compression sleeve. At least one of the one or more long sleeves 21 is desirably configured to hold each of the wrist sensor 11 and the shoulder sensor 12 in place during a baseball swing. This may be accomplished by, for example, having the long sleeve 21 fit tightly against the body of the wearer, at least in the locations of the wrist sensor 11 and shoulder sensor 12. The long sleeve 21 should not, however, restrict wearer movement or otherwise interfere with a baseball swing motion.

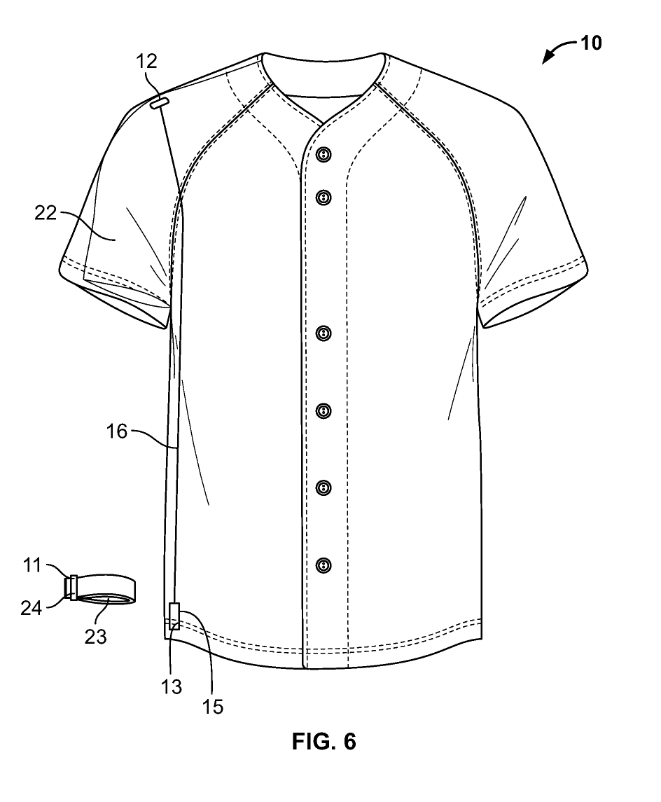

In other embodiments, the garment 10 may be short-sleeved. For example, in some embodiments, the garment 10 may be a short-sleeved garment made of a stretchable, optionally high-performance fabric. In other embodiments, the garment 10 may have the outward appearance of a conventional baseball jersey. For example, as in the embodiment illustrated in FIG. 6, the garment 10 may comprise a (short-sleeved) baseball jersey having one or more sleeve inserts 22. The one or more sleeve inserts 22 may be attached to the short-sleeved baseball jersey by any conventional manner. For example, the one or more sleeve inserts 22 may be sewn into the interior of the short-sleeved baseball jersey. The one or more sleeve inserts 22 may be made of a stretchable, optionally high-performance fabric. At least one of the one or more sleeve inserts 22 is desirably configured to hold the shoulder sensor 12 in place during a baseball swing. This may be accomplished by, for example, having the sleeve insert 22 fit tightly against the body of the wearer, at least at the location of the shoulder sensor 12. The sleeve insert 22 should not, however, restrict wearer movement or otherwise interfere with a baseball swing motion. The sleeve insert 22 may span substantially the length of the baseball jersey sleeve, such as shown in the embodiment illustrated in FIG. 6, or any other, preferably shorter, distance down the wearer's arm. In some embodiments, for example, the sleeve insert 22 may span only a small region in the immediate vicinity of the shoulder sensor 12.

In these embodiments where the garment 10 is short-sleeved, the wrist sensor 11 may not be incorporated into the garment. Rather, the wrist sensor 11 may be configured to be worn on a user's wrist. For example, the wrist sensor 11 may be incorporated into a wristband 23. Where the wrist sensor 11 is not incorporated into the garment, it should be configured to communicate either (a) directly with an external unit, e.g. the same external unit to which the wireless transmitter 14 is configured to communication, or (b) the control module 15. The wrist sensor 11 may thus be operably connected to its own wireless transmitter 24 (which for example may also be incorporated into a wristband 23). The type of wireless communication technology that is employed by the wireless transmitter 24 is not limited and may be selected from those generally known in the art, such as Wi-Fi, Bluetooth or other radio wave-based wireless, induction wireless, infrared wireless, ultra wideband (UWB), or the like.

It should also be understood that in those embodiments where the wrist sensor 11 is configured to communicate with the control module 15, the control module may comprise a wireless receiver. In some embodiments, for example, it may be desirable for the wireless transmitter 24 associated with the wrist sensor 11 to communicate the sensor data to the control module 15 via a short-range wireless technology such as Bluetooth or the like. At the same time, it may be desirable for the wireless transmitter 14 associated with the control module 15 to transmit the data from the plurality of sensors (or in some embodiments the processed data) to an external unit using a longer-range wireless technology, such as Wi-Fi or the like.

The above-described embodiments are exemplary and non-limiting. It will be appreciated that other garment types, designs, and styles are also suitable for use with the invention described herein.

### The System

The present disclosure also relates to a system 100 for analyzing a user's baseball swing. The system 100 comprises the garment 10 according to any of the embodiments described above. The system 100 also comprises an external unit 30. The external unit 30 may be configured to receive the wireless transmission of sensor data from the wireless transmitter 14, process that sensor data to convert it into user swing information, and then display the user swing information.

Accordingly, the external unit 30 generally comprises a display 31 that is configured to display the user swing information. The external unit 30 also typically comprises a processor that is configured to convert the data from the plurality of sensors into user swing information. In some embodiments, the processor may be incorporated into the garment 10, such as for example by inclusion of a processor in the control module 15. More desirably, however, the processor is located in the external unit 30. The external unit 30 may also comprise more than one component. For example, the component comprising the display 31 may be separate from the component comprising the processor.

In some embodiments, the external unit 30 may comprise a personal computer, such as a laptop computer or a desktop computer. Alternatively, the external unit 30 may comprise a handheld device, such as a smartphone or tablet computer. In each of these embodiments, the device that serves as the external unit 30 comprises a built-in processor and screen (display). Accordingly, the system 100 may also comprise a program or “app” that is configured to cause the processor to convert the data from the plurality of sensors into swing information and to display the swing information on the screen of the device. In alternative embodiments, the system may comprise a stand-alone external unit 30 that is specially configured for processing data from the sensors and displaying user swing information.

According to embodiments of the present disclosure, the system 100 may comprise one or more garments 10, one or more external units 30, or both. For example, in some embodiments, the system 100 may be configured so that an individual, such as a hitting coach, could simultaneously track the swings of multiple batters, each wearing a garment 10 in accordance with the above disclosure, on a single external unit 30. Alternatively, sensor data from a single garment 10 could be transmitted to multiple external units 30 so that multiple individuals could analyze a batter's swing, scout the batter, or the like.

The user swing information may comprise any of a variety of swing metrics, parameters, and the like. Individual types of swing information are described in more detail below. It is contemplated that the system 100 may be configured to compute any variety of swing information, including combinations of the types of swing information specifically described below, as well as types of swing information not specifically described.

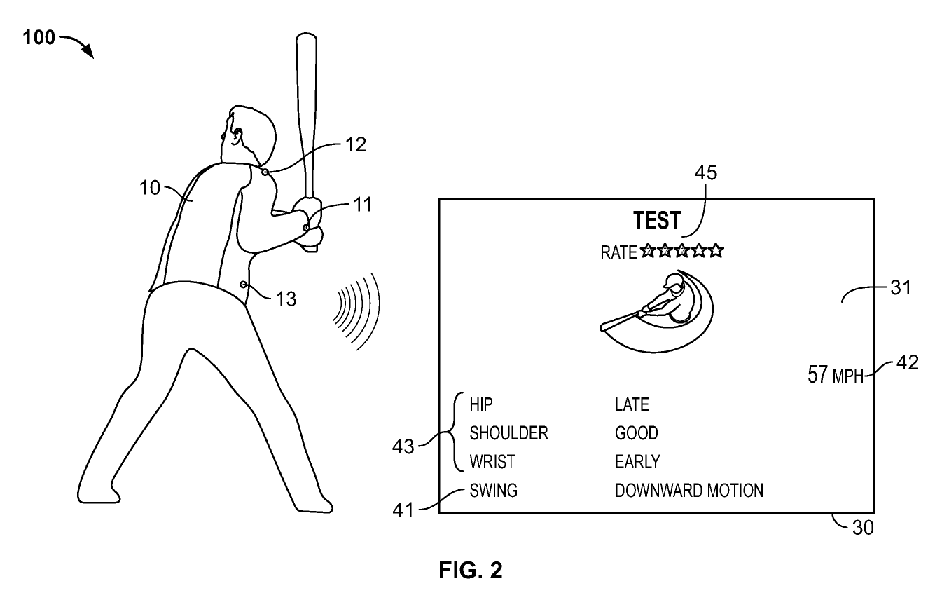

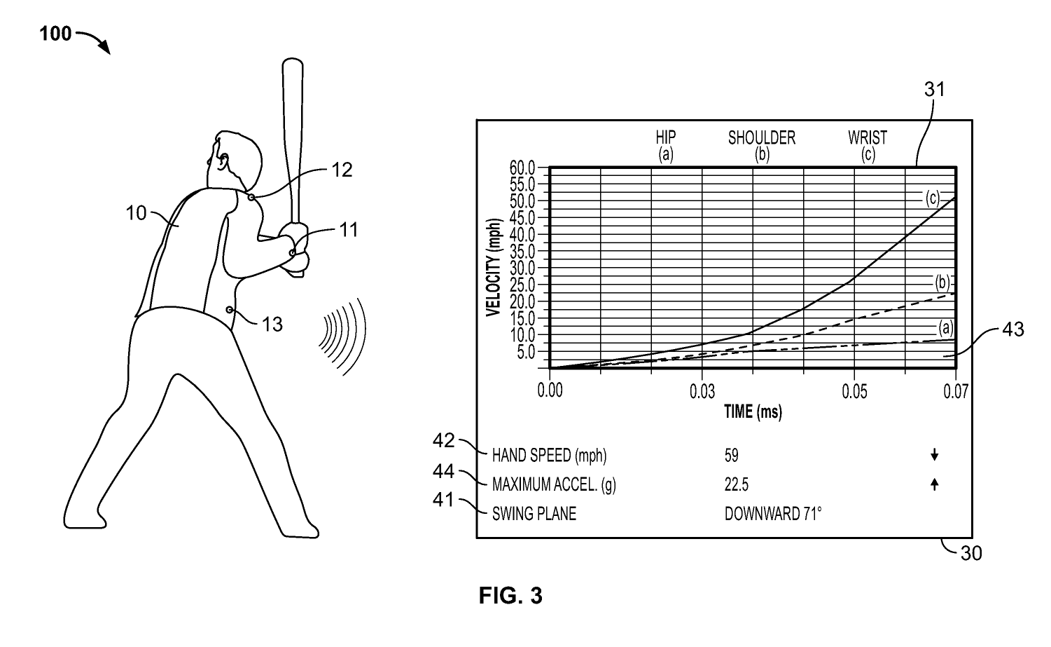

In some embodiments, the system 100 may be configured to compute and display a user's swing plane or swing path. Swing plane information identifies, for example, whether the user's swing was characterized by a downward motion, an upward motion, or the maintenance of a level plane. The swing plane of a batter's swing is closely related to what type of contact the player makes with the ball and whether that contact is likely to result in a groundball, fly ball, or line drive. In the embodiments of the system 100 illustrated in FIG. 2 and FIG. 3, for example, the display 31 comprises swing plane information 41. In each Figure, the swing plane information 41 is shown as having a downward component. In the embodiment shown in FIG. 3, the hit angle, i.e. the specific downward or upward angle of the swing plane, is also displayed. The layout of the display 31 shown in each of the Figures is meant to be exemplary only and it is contemplated that the manner in which the swing plane information 41 is displayed may be altered or adjusted without departing from the scope of the present disclosure.

In some embodiments, the system 100 may be configured to compute and display a user's hand speed. Hand speed information relates, for example, to the speed with which a batter gets the bat through the strike zone, as well as to the strength of the contact made by the batter. In the embodiments of the system illustrated in FIG. 2 and FIG. 3, for example, the display 31 comprises hand speed information 42. In each Figure, the hand speed information 42 includes the miles per hour of the batter's hands during the swing. In the embodiment shown in FIG. 3, a downward arrow also indicates that the hand speed has decreased in comparison with a previous swing or that the speed was less than a predetermined threshold or target value. The layout of the display 31 shown in each of the Figures is meant to be exemplary only and it is contemplated that the manner in which the hand speed information 42 is displayed may be altered or adjusted without departing from the scope of the present disclosure.

In some embodiments, the system 100 may be configured to compute and display information relating to the timing of the batter's hand (or hands), shoulder (or shoulders), and hip (or hips). A good baseball swing requires that the batter's hands, shoulders, and hips all work in conjunction with one another to produce a desired motion of the baseball bat and to create power as the batter moves the baseball bat through the strike zone. Accordingly, information regarding the movement of these body parts relative to one another may be of significant value in the analysis of a baseball swing and of a batter's consistent ability to repeat a swing. For example, the system 100 may provide information as to whether a batter's shoulder movement was late in comparison to the batter's hands, whether a batter's hips were early in comparison to the batter's shoulder, and the like.

In the embodiment of the system illustrated in FIG. 2, for example, the display 31 comprises information relating to the timing of the batter's hand, shoulder, and hip 43. In this embodiment, the raw data from the sensors 11, 12, 13 is compiled and processed in order to determine the relative timing of each body part. The information 43 is then displayed in a manner by which a user may, with little or no independent analysis of the data, easily understand the results. For example, in the embodiment shown in FIG. 2, the display 31 indicates whether the timing of the batter's hip is (a) early, (b) late, (c) good (on-time), or (d) needs work (indicating an undesirable movement or lack of movement); whether the timing of the batter's shoulder is (a) early, (b) late, (c) good, or (d) needs work; and whether the timing of the batter's wrist or hand is (a) early, (b) late, (c) good, or (d) needs work. Upon seeing this information, a batter may easily identify the appropriate adjustment. The layout of the display 31 shown in FIG. 2 is meant to be exemplary only and it is contemplated that the manner in which the hand, shoulder, and hip timing information 43 is displayed may be altered or adjusted without departing from the scope of the present disclosure.

In the embodiment of the system illustrated in FIG. 3, for example, the display 31 also comprises information relating to the timing of the batter's hand, shoulder, and hip 43. Here the information 43 is displayed in a graphical format, which shows the speed of each body part at each point in time during a swing. A skilled user, such as a hitting coach, will be able to use the graphical information 43 in order to recognize problem areas, swing discrepancies (such as may occur when swinging at a certain type of pitch), and the like. The graphical format of the information 43 may also allow one to more effectively compare a batter's individual swings against one another or against a predetermined target swing. The graphical display also allows one to analyze the batter's body movement during a swing with an enhanced degree of precision. The layout of the display 31 shown in FIG. 3 is meant to be exemplary only and it is contemplated that the manner in which the hand, shoulder, and hip timing information 43 is displayed may be altered or adjusted without departing from the scope of the present disclosure.

In some embodiments, the system 100 may be configured to compute and display information relating to a user's swing acceleration. The overall amount of the acceleration, as well as the acceleration profile, obtained by the batter during a swing provides some indication of how quickly the batter gets the bat into and/or through the strike zone, as well as the power of the swing at the critical point where it makes contact with the ball. In the embodiment of the system illustrated in FIG. 3, for example, the display 31 comprises information relating to the batter's maximum hand acceleration 44. It is also contemplated that the acceleration information may be displayed, e.g. graphically, in a manner that shows the acceleration profile, including for example the point of the swing in which the maximum acceleration of one or more body parts occurred. The layout of the display 31 shown in FIG. 3 is meant to be exemplary only and it is contemplated that the manner in which the swing acceleration information 44 is displayed may be altered or adjusted without departing from the scope of the present disclosure.

In some embodiments, the system 100 may be configured to compute and display a swing rating. The swing rating may be used as a shorthand way for a user to identify the overall quality of the swing, as determined by the system based on the data from the plurality of sensors. In the embodiment of the system 100 illustrated in FIG. 2, for example, the display 31 comprises swing rating information 45 that is measured on a scale from zero stars to five stars. It is also contemplated, for example, that the swing rating may be displayed numerically, such as by providing a swing with a value between, for example, zero and ten or between zero and one hundred. The layout of the display 31 shown in FIG. 2 is meant to be exemplary only and it is contemplated that the manner in which a swing rating 45 is displayed may be altered or adjusted without departing from the scope of the present disclosure.

In some embodiments, the system 100 may be configured to compute and display bat speed information. The speed of the bat during a swing can be calculated using the data collected by the plurality of sensors and the bat length. Accordingly, in some embodiments, the system 100 may be configured to prompt a user to enter the length of the bat that is used during a swing or series of swings. The system 100 may then calculate the bat speed and that information may be displayed to a user in any of a variety of ways.

In some embodiments, the system 100 may be configured to compute and display information relating to the batter's hit point. Hit point information can be calculated using the data collected by the plurality of sensors and the orientation of the batter with home plate. Accordingly, for example, in some embodiments, the system 100 may also comprise one or more sensors that are configured to orient the user with home plate, e.g. one or more sensors located on or near home plate. Alternatively, a user may be prompted to enter information relating to the batter's stance as it relates to home plate. The system 100 may then calculate hit point information and that information may be displayed to a user in a variety of ways.

In some embodiments, the system 100 may be configured to compute and display information relating to the batter's time in the zone. Time in the zone information could be displayed to a user in any of a variety of ways. For example, this information may include a graphic overlay showing home plate and indicating the time during the swinging motion that the batter would maintain the bat over the plate.

In some embodiments, the system 100 may be configured to display a swing animation, i.e. a simulation of the batter's swing. The animation could be configured to focus the user on certain portions of the batter's swing, such as one or more areas where improvement may be desirable. The animation could also be compared against a control swing, such as a swing by the batter that was deemed of high quality, an idealized version of the user's swing, a programmed target swing, or the like. In some embodiments, the animation could be compared against a target swing that is based on the swing of a professional baseball player to which the batter aspired or was thought to possess a similar swing. In some embodiments, the animation could be compared against a batter's swing from a period of time before certain adjustments were made or before an injury occurred. The system 100 could also be configured to identify differences between the current swing and the prior swing or the target swing, and to provide swing improvement advice based on these differences.

In some embodiments, the system 100 may be configured to identify the expected path of the ball. For example, based on the data from the plurality of sensors, and any other optional data that is input into the system, each swing could be tagged with a hit type (e.g. line drive, grounder, fly ball, etc.), a direction (e.g. left, center, right, foul ball, etc.), and/or a distance that the ball would be expected to travel. This information could be displayed to a user in any of a variety of ways. For example, the system could be configured to display the information to the user with text or visually, such as with an animation.

The system may be configured to display any combination of the above-described swing information and may also include swing information not specifically described herein. The user swing information may also be displayed in any of a variety of ways. In some embodiments, for example, the user swing information is at least partially displayed graphically or with an animation.

In some embodiments, the user swing information from one or more swings may be stored, such as in a memory. For instance, a user may create a training session into which an amount of swing information across a number of swings may be compiled and stored. In some embodiments, therefore, swing information from multiple training sessions may be compared against one another. Because the information is stored, the comparison may be performed, for example, after a training session or at any other time when it is convenient. This may be used, for example, to track the improvement of a user's swing, to track a user's adjustments to the swing in response to certain types of pitches, to accurately compare a user's post-injury swing with the user's pre-injury swing, and the like. In some embodiments, the system may be configured to offer swing improvement advice based on stored swing data.

In some embodiments, the system 100 may be configured to produce or take into account a performance goal. For example, the system may prompt a user to input a performance goal. Alternatively, the system 100 may be configured to develop a performance goal for a user based on the data from the plurality of sensors. The user's swing data may then be compared against the performance goal. The system 100 may also be configured to provide improvement tips based on the performance goal and the swing data.

In some embodiments, the system 100 may be configured to have multiple display modes. For example, in some embodiments, the system 100 may include at least a first mode and second mode, wherein the user swing information that is selectable or displayed in the first mode is different from the user swing information that is selectable or displayed in the second mode. The first mode may provide a streamlined user interface in which basic swing metrics may be easily analyzed by a user. Because it is contemplated that this mode is most likely to be used by a batter, such as during a training session, this mode may be referred to as a “Batter” mode. The second mode may provide a more advanced user interface in which advanced swing metrics may be analyzed. Because it is contemplated that this mode is most likely to be used by a hitting coach, such as after a batter's training session, this mode may be referred to as a “Coach” mode. By way of example, the first or “Batter” mode may display user swing information in a manner such as that shown in FIG. 2, while the second or “Coach” mode may display user swing information in a manner such as that shown in FIG. 3. Although the second mode may generally include more advanced swing analysis features, there are no specific limitations to the type of user swing information that may be present in either mode.

In some embodiments, the system 100 may be configured for the sharing of user swing information, such as over the Internet, e.g. through email, social media, and the like.

### The Method

The present disclosure also relates to a method for analyzing a user's baseball swing. The method involves having a batter don the garment 10 according to any of the embodiments described above while performing a baseball swing. The garment 10, such as through its wireless transmitter 14, transmits the data from the plurality of sensors to an external unit 30. The data that is transmitted from the plurality of sensors is processed to produce user swing information and the user swing information is displayed in a manner that can be viewed by a user. In alternative embodiments, the processing of the data collected by the plurality of sensors may be performed prior to transmission to the external unit 30, such as by one or more processors incorporated into the control unit 15.

In some embodiments, for example, the external unit 30 may comprise a personal computer, such as a laptop computer or a desktop computer. Alternatively, the external unit 30 may comprise a handheld device, such as a smartphone or tablet computer. In each of these embodiments, the device that serves as the external unit 30 comprises a built-in processor and screen. Accordingly, the method may utilize a program or “app” that is configured to cause the processor to convert the data from the plurality of sensors into swing information and to display the swing information on the screen of the device. In some embodiments, the external unit may be positioned so that the swing information can be viewed by a batter without requiring the batter to step out of the batter's box.

According to embodiments of the present disclosure, the method may make use of one or more garments 10, one or more external units 30, or both. For example, in some embodiments, a hitting coach might simultaneously track the swings of multiple batters, each wearing a garment 10 in accordance with the above disclosure, on a single external unit 30. Alternatively, sensor data from a single garment 10 could be transmitted to multiple external units 30 so that multiple individuals could analyze a batter's swing, scout the batter, or the like.

The user swing information may comprise any of a variety of information. Individual types of swing information are described in more detail below. It is contemplated that the method may be used to provide any variety of swing information, including combinations of the types of swing information provided below, as well as types of swing information not specifically described.

In some embodiments, the method may be used to determine and display a user's swing plane or swing path. Swing plane information identifies, for example, whether the user's swing was characterized by a downward motion, an upward motion, or the maintenance of a level plane. The swing plane of a batter's swing is closely related to what type of contact the player makes with the ball and whether that contact results in a groundball, fly ball, or line drive. In the embodiments illustrated in FIG. 2 and FIG. 3, for example, the display 31 comprises swing plane information 41. In each embodiment, the swing plane information 41 is shown as having a downward component. In the embodiment shown in FIG. 3, the hit angle, i.e. the specific downward or upward angle of the swing plane is also displayed. The display 31 shown in each of the Figures is meant to be exemplary only and it is contemplated that the manner in which the swing plane information 41 is displayed may be altered or adjusted without departing from the scope of the present disclosure.

In some embodiments, the method may be used to determine and display a user's hand speed. Hand speed information relates, for example, to the speed with which a batter gets the bat through the strike zone and to the strength of the contact made by the batter. In the embodiments illustrated in FIG. 2 and FIG. 3, for example, the display 31 comprises hand speed information 42. In each embodiment, the hand speed information 42 indicates the miles per hour of the batter's hands during the swing. In the embodiment shown in FIG. 3, a downward arrow also indicates that the hand speed has decreased in comparison with a previous swing or that the speed was less than a predetermined threshold or target value. The display 31 shown in each of the Figures is meant to be exemplary only and it is contemplated that the manner in which the hand speed information 42 is displayed may be altered or adjusted without departing from the scope of the present disclosure.

In some embodiments, the method may be used to determine and display information relating to the timing of the batter's hand or hands, shoulder or shoulders, and hip or hips. A good baseball swing requires that the batter's hands, shoulders, and hips all work in conjunction with one another to produce a desired motion of the baseball bat and to create power as the baseball bat moves through the strike zone. Accordingly, information regarding the movement of these body parts relative to one another may be of significant value in the analysis of a baseball swing or of a batter's consistent ability to repeat a swing. For example, the method may provide information as to whether a batter's shoulder movement was late in comparison to the batter's hands, whether a batter's hips were early in comparison to the batter's shoulder, and the like.

In the embodiment illustrated in FIG. 2, for example, the display 31 comprises information relating to the timing of the batter's hand, shoulder, and hip 43. In this embodiment, the raw data from the sensors 11, 12, 13 is compiled and processed in order to determine the relative timing of each body part. The information 43 is then displayed in a manner by which a user may, with little or no independent analysis of the data, understand the results. For example, in the embodiment shown in FIG. 2, the display 31 indicates whether the timing of the batter's hip is (a) early, (b) late, (c) good (on-time), or (d) needs work (indicating undesirable movement or lack of movement); whether the timing of the batter's shoulder is (a) early, (b) late, (c) good, or (d) needs work; and whether the timing of the batter's wrist or hand is (a) early, (b) late, (c) good, or (d) needs work. Upon seeing this information, a batter may easily identify the appropriate adjustment. The display 31 shown in FIG. 2 is meant to be exemplary only and it is contemplated that the manner in which the hand, shoulder, and hip timing information 43 is displayed may be altered or adjusted without departing from the scope of the present disclosure.

In the embodiment illustrated in FIG. 3, for example, the display 31 comprises information relating to the timing of the batter's hand, shoulder, and hip 43. The information 43 is displayed in a graphical format, which shows the speed of each body part at each point in time during a swing. A skilled user, such as a hitting coach, will be capable of recognizing problem areas or swing discrepancies (such as may occur when swinging at a certain type of pitch) using the graphical information 43. The graphical format of the information 43 may also allow one to effectively compare a batter's individual swings against one another or against a predetermined target swing. The graphical display also allows one to analyze the batter's body movement during a swing with an increased degree of precision. The display 31 shown in FIG. 3 is meant to be exemplary only and it is contemplated that the manner in which the hand, shoulder, and hip timing information 43 is displayed may be altered or adjusted without departing from the scope of the present disclosure.

In some embodiments, the method may be used to determine and display information relating to a user's swing acceleration. The amount and timing of the acceleration obtained by the batter during a swing provides some indication of how quickly the batter gets the bat into and/or through the strike zone, as well as the power of the swing at the critical point where it makes contact with the ball. In the embodiment illustrated in FIG. 3, for example, the display 31 comprises information relating to the batter's maximum hand acceleration 44. It is also contemplated that the acceleration information may be displayed, e.g. graphically, in a manner that shows the point of the swing in which the maximum acceleration of one or more body parts occurred. The display 31 shown in FIG. 3 is meant to be exemplary only and it is contemplated that the manner in which the swing acceleration information 44 is displayed may be altered or adjusted without departing from the scope of the present disclosure.

In some embodiments, the method may be used to determine and a swing rating. The swing rating may be used as a shorthand way for a user to identify the overall quality of the swing, as determined by the system by processing the data from the plurality of sensors. In the embodiment illustrated in FIG. 2, for example, the display 31 comprises swing rating information 45 that is measured on a scale from zero stars to five stars. It is also contemplated, for example, that the swing rating may be displayed numerically, such as by providing a swing with a value between, for example, zero and ten or between zero and one hundred. The display 31 shown in FIG. 2 is meant to be exemplary only and it is contemplated that the manner in which a swing rating 45 is displayed may be altered or adjusted without departing from the scope of the present disclosure.

In some embodiments, the method may be used to determine and display bat speed information. The speed of the bat during a swing can be calculated using the data collected by the plurality of sensors and the bat length. Accordingly, in some embodiments, a user may be prompted to enter the length of the bat that is used during a swing or series of swings. The processor may then calculate the bat speed, which information may be displayed to a user in any of a variety of ways.

In some embodiments, the method may be used to determine and display information relating to the batter's hit point. Hit point information can be calculated using the data collected by the plurality of sensors and the orientation of the batter with home plate. Accordingly, for example, in some embodiments, one or more sensors that are configured to orient the user with home plate, e.g. one or more sensors located on home plate, may be used. Alternatively, a user may be prompted to enter information relating to the batter's stance as it relates to home plate. The processor may then calculate hit point information, which information may be displayed to a user in a variety of ways.

In some embodiments, the method may be used to determine and display information relating to the batter's time in the zone. Time in the zone information could be displayed to a user in any of a variety of ways. For example, this information may include a graphic overlay showing home plate and indicating the time during the swinging motion that the batter would maintain the baseball bat over the plate.

In some embodiments, the method may be used to determine and display a swing animation, i.e. a simulation of the batter's swing. The animation could be configured so as to focus the user on certain portions of the batter's swing, such as areas where improvement may be desirable. The animation could also be compared against a control swing, such as a swing by the batter that was deemed of high quality, an idealized target swing, and the like. In some embodiments, the animation could be compared against a target swing that incorporated the swing of a professional baseball player to which the batter aspired or was compared. In some embodiments, the animation could be compared against a batter's swing from a period of time before certain adjustments were made or before an injury occurred. The animation could also be used to identify differences between the current swing and the prior swing or the target swing and to provide swing improvement advice based on these differences.

In some embodiments, the method may be used to determine and the expected path of the ball. For example, based on the data from the plurality of sensors, and any other optional data that is input to the processor, each swing could be tagged with a hit type (e.g. line drive, grounder, fly ball, etc.), a direction (e.g. left, center, right, foul ball, etc.), and/or a distance that the ball would be expected to travel. This information could be displayed to a user in any of a variety of ways. For example, the information could be displayed to the user with text or through an animation.

The method may be used to determine and display any combination of the above-described swing information. Any of the swing information may also be compared with that from a previous swing or with a control or target value. This may, for example, provide an easy way for a user to track his improvement in any certain area or metric over the course of numerous swings or training sessions.

In some embodiments, the user swing information from one or more swings may be stored, such as in a memory. For instance, a user may create a training session into which an amount of swing information across a number of swings may be compiled and stored. In some embodiments, therefore, swing information from multiple swings or multiple training sessions may be compared against one another. The comparison may be performed, for example, after a training session or at any time when convenient. This may be used, for example, to track the improvement of a user's swing, to track a user's adjustments to the swing in response to certain types of pitches, to accurately compare a user's post-injury swing with the user's pre-injury swing, and the like.

In some embodiments, the method may take into account a performance goal. For example, a user may be prompted to input a performance goal. Alternatively, the processor may be configured to develop a performance goal for a user based on the data from the plurality of sensors. The user's swing data may then be compared against the performance goal. Improvement tips based on the performance goal and the swing data may be provided.

In some embodiments, a user may share his or her user swing information, such as over the Internet, e.g. through email, social media, and the like.

It can be seen that the described embodiments provide a unique and novel garment 10 and system 100 that has a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A garment configured for analyzing a wearer's baseball swing comprising:
a plurality of sensors, the plurality of sensors including
a wrist sensor configured to detect motion of a wearer's wrist or hand,
a shoulder sensor configured to detect motion of a wearer's shoulder, and
a hip sensor configured to detect motion of a wearer's hip; and
a wireless transmitter configured to transmit data from the plurality of sensors to an external unit.

2. The garment of claim 1, in which the plurality of sensors consists of one wrist sensor, one shoulder sensor, and one hip sensor.

3. The garment of claim 1, in which each of the plurality of sensors is connected to at least one other of the plurality of sensors through a flexible ribbon, the flexible ribbon being incorporated into the garment.

4. The garment of claim 3, in which the garment comprises a tunnel through which the flexible ribbon extends.

5. The garment of claim 1, in which at least one of the plurality of sensors is irremovably incorporated into the garment.

6. The garment of claim 5, in which the garment is configured to be machine-washable without damaging the irremovably incorporated sensors.

7. The garment of claim 1, further comprising a control module comprising the wireless transmitter.

8. The garment of claim 7, in which each of the plurality of sensors is connected to at least one other of the plurality of sensors through a flexible ribbon that is incorporated into the garment, and the flexible ribbon is configured to removably link with the control module.

9. The garment of claim 8, in which the control module is removable from the garment.

10. The garment of claim 1, wherein the garment is a baseball jersey having one or more long compression sleeves attached.

11. A system for analyzing a user's baseball swing, the system comprising:
the garment of claim 1;
a processor configured to convert the data from the plurality of sensors into user swing information; and
a display configured to display the user swing information.

12. The system of claim 11, wherein the user swing information comprises a user's swing plane; hand speed; swing acceleration; maximum acceleration; hit angle; bat speed; time in the strike zone; hit point; information regarding the relative timing of hip, shoulder, and/or wrist movements; or a combination thereof.

13. The system of claim 11, in which the system is configured to store and compare user swing information from multiple swings.

14. The system of claim 11, in which the system is configured to provide swing improvement advice.

15. The system of claim 11, in which the system is configured to have at least a first mode and a second mode, wherein the user swing information that is selectable in the first mode is different from the user swing information that is selectable in the second mode.

16. A method for analyzing a user's baseball swing using the garment of claim 1, comprising:
causing the user to wear the garment while performing a baseball swing;
transmitting data from the plurality of sensors to an external unit;
processing the data to produce user swing information; and
displaying the user swing information.

17. A system configured for analyzing a wearer's baseball swing comprising:
a garment comprising
a plurality of sensors, the plurality of sensors including at least
a shoulder sensor configured to detect motion of a wearer's shoulder, and
a hip sensor configured to detect motion of a wearer's hip; and
a first wireless transmitter configured to transmit data from the plurality of sensors to an external unit; and
a wristband comprising
a wrist sensor configured to detect motion of a wearer's wrist or hand, and
a second wireless transmitter configured to transmit data from the wrist sensor to at least one of (i) the external unit and (ii) a receiver associated with the first wireless transmitter.

18. The system of claim 17, wherein the garment is a baseball jersey comprising at least one sleeve insert, the sleeve insert being configured to hold the shoulder sensor in place during a baseball swinging motion.

19. The system of claim 17, in which the plurality of sensors consists of one shoulder sensor and one hip sensor.

20. The system of claim 17, in which at least one of the plurality of sensors is irremovably incorporated into the garment.

21. The system of claim 17, further comprising an external unit, the external unit comprising
a processor configured to convert the data from the sensors into user swing information, and
a display configured to display the user swing information.

22. The system of claim 21, wherein the user swing information comprises a user's swing plane; hand speed; swing acceleration; maximum acceleration; hit angle; bat speed; time in the strike zone; hit point; information regarding the relative timing of hip, shoulder, and/or wrist movements; or a combination thereof.

23. The system of claim 21, in which the system is configured to store and compare user swing information from multiple swings.

24. The system of claim 21, in which the system is configured to provide swing improvement advice.

25. The system of claim 21, in which the system is configured to have at least a first mode and a second mode, wherein the user swing information that is selectable in the first mode is different from the user swing information that is selectable in the second mode.

26. A method for analyzing a user's baseball swing using the system of claim 17, comprising:
causing the user to wear the garment and wristband while performing a baseball swing;
transmitting data from the sensors to an external unit;
processing the data to produce user swing information; and
displaying the user swing information.
